(19) United States
(12) Patent Application Publication
(10) Pub. No.: US 2020/0193459 A1
(43) Pub. Date: Jun. 18, 2020

(54) Method, System, and Computer Program Product for Generating a Classified Map

(71) Applicant: Visa International Service Association, San Francisco, CA (US)

(72) Inventors: Sukalyan Chakraborty, Foster City, CA (US); Ramesh Bonigi, Fremont, CA (US); Nelson Dsouza, Mountain View, CA (US); Nikhil Ghate, Sunnyvale, CA (US); Urjit Anand Khadilkar, San Mateo, CA (US)

(21) Appl. No.: 16/220,509

(22) Filed: Dec. 14, 2018

(51) Int. Cl. G06Q 30/02; G06K 9/62; G06Q 20/38; G06F 17/18; G06N 20/00; G06F 16/29

(52) U.S. Cl. CPC G06Q 30/0205; G06K 9/6218; G06F 16/29; G06F 17/18; G06N 20/00; G06Q 20/38

(57) ABSTRACT

A computer-implemented method for generating a classified map on a computing device includes: receiving statistical data associated with each zone of a plurality of zones; generating based on the statistical data at least one classification score for each zone of the plurality of zones by performing a latent factor analysis on the statistical data to generate at least one latent factor score; causing to be displayed a map of a geographic region having the plurality of zones on a display of a computing device; based at least partially on the at least one classification score, causing at least one classification tag to be overlayed over each zone of the plurality of zones on the map to generate the classified map. A system and computer program product for generating a classified map on a computing device are also disclosed.

### BACKGROUND

### Field

This disclosure relates to computer-implemented classification of geographic regions and, in one non-limiting embodiment or aspect, to a method, system, and computer program product for generating a classified map on a computing device.

### Description of Related Art

Individuals, groups of individuals, and organizations often make locational decisions based on perceived and/or amorphous classifications of various geographic regions. Non-limiting examples of locational decisions can include where to vacation, where to live, or where to locate a business.

The classifications associated with various geographic regions are often subjective and rooted in unsubstantiated and/or unquantified analysis. For example, supporting a conclusion that a geographic region is affluent, affordable, or youthful (example classifications) is a seemingly subjective endeavor. Thus, existing systems of classifying geographic regions often cause individuals, groups of individuals, and organizations making locational decisions to make incompletely informed decisions by relying on the subjective data or opinions.

Therefore, it would be desirable to more objectively classify geographic regions based on available statistical data and to generate an easily perceivable means for individuals, groups of individuals, and organizations to interpret the objectively classified geographic regions, in order to make a decision regarding location.

### SUMMARY

Accordingly, and generally, provided is an improved method, system, and computer program product for generating a classified map on a computing device.

According to a non-limiting embodiment or aspect, a computer-implemented method for generating a classified map on a computing device includes: receiving, with at least one processor, statistical data associated with each zone of a plurality of zones; generating, with at least one processor, based on the statistical data at least one classification score for each zone of the plurality of zones by performing a latent factor analysis on the statistical data to generate the at least one classification score; causing to be displayed, with at least one processor, a map of a geographic region having the plurality of zones on a display of a computing device; based at least partially on the at least one classification score, causing to be overlayed, with at least one processor, at least one classification tag over each zone of the plurality of zones on the map to generate the classified map.

In one non-limiting embodiment or aspect, the statistical data may include transaction data associated with transactions initiated in each zone of the plurality of zones and merchant category codes associated with the transactions. The classification score for each zone may be generated based at least partially on at least one latent factor score. The statistical data may include socioeconomic data. The statistical data may include a count of transactions initiated in each zone of the plurality of zones sorted by merchant category codes associated with the transactions; where generating the at least one classification score includes performing, with at least one processor, the latent factor analysis on the transaction data to generate at least one latent factor score associated with each merchant category code; where generating the at least one classification score further includes associating at least one classification tag with each merchant category code based at least partially on the at least one latent factor score; and where the at least one classification score is based at least partially on the at least one classification tag associated with each merchant category code. Associating the at least one classification tag with each merchant category code may include performing a machine learning clustering technique. Generating the at least one classification score may include performing, with at least one processor, the latent factor analysis on the transaction data to generate a first latent factor score associated with each merchant category code and a second latent factor score associated with each merchant category code, where generating the at least one classification score further includes plotting a graph of the first latent factor score against the second latent factor score for each merchant category code and associating the at least on classification tag with each merchant category code based on clustering of the merchant category codes on the graph.

According to a non-limiting embodiment or aspect, a system for generating a classified map on a computing device includes at least one processor programmed or configured to: receive statistical data associated with each zone of a plurality of zones; generate, based on the statistical data, at least one classification score for each zone of the plurality of zones by performing a latent factor analysis on the statistical data to generate the at least one classification score; cause to be displayed a map of a geographic region having the plurality of zones on a display of a computing device; and based at least partially on the at least one classification score, cause to be overlayed at least one classification tag over each zone of the plurality of zones on the map to generate the classified map.

In one non-limiting embodiment or aspect, the statistical data may include transaction data associated with transactions initiated in each zone of the plurality of zones and merchant category codes associated with the transactions. The classification score for each zone may be generated based at least partially on at least one latent factor score. The statistical data may include socioeconomic data. The statistical data may include a count of transactions initiated in each zone of the plurality of zones sorted by merchant category codes associated with the transactions; where generating the at least one classification score includes the at least one processor performing the latent factor analysis on the transaction data to generate at least one latent factor score associated with each merchant category code; where generating the at least one classification score includes the at least one processor associating at least one classification tag with each merchant category code based at least partially on the at least one latent factor score; and where the at least one classification score is based at least partially on the at least one classification tag associated with each merchant category code. Associating the at least one classification tag with each merchant category code may include the at least one processor performing a machine learning clustering technique. Generating the at least one classification score may include the at least one processor performing the latent factor analysis on the transaction data to generate a first latent factor score associated with each merchant category code and a second latent factor score associated with each merchant category code, where generating the at least one classification score further includes the at least one processor plotting a graph of the first latent factor score against the second latent factor score for each merchant category code and associating the at least on classification tag with each merchant category code based on clustering of the merchant category codes on the graph.

According to a non-limiting embodiment or aspect, a computer program product for generating a classified map on a computing device includes at least one non-transitory computer-readable medium including one or more instructions that, when executed by at least one processor, cause the at least one processor to: receive statistical data associated with each zone of a plurality of zones; generate, based on the statistical data, at least one classification score for each zone of the plurality of zones by performing a latent factor analysis on the statistical data to generate the at least one classification score; cause to be displayed a map of a geographic region having the plurality of zones on a display of a computing device; and based at least partially on the at least one classification score, cause to be overlayed at least one classification tag over each zone of the plurality of zones on the map to generate the classified map.

In one non-limiting embodiment or aspect, the statistical data may include transaction data associated with transactions initiated in each zone of the plurality of zones and merchant category codes associated with the transactions. The classification score for each zone may be generated based at least partially on at least one latent factor score. The statistical data may include socioeconomic data. The statistical data may include a count of transactions initiated in each zone of the plurality of zones sorted by merchant category codes associated with the transactions; where generating the at least one classification score includes the at least one processor performing the latent factor analysis on the transaction data to generate at least one latent factor score associated with each merchant category code; where generating the at least one classification score includes the at least one processor associating at least one classification tag with each merchant category code based at least partially on the at least one latent factor score; and where the at least one classification score is based at least partially on the at least one classification tag associated with each merchant category code. Associating the at least one classification tag with each merchant category code may include the at least one processor performing a machine learning clustering technique. Generating the at least one classification score may include the at least one processor performing the latent factor analysis on the transaction data to generate a first latent factor score associated with each merchant category code and a second latent factor score associated with each merchant category code, where generating the at least one classification score further includes the at least one processor plotting a graph of the first latent factor score against the second latent factor score for each merchant category code and associating the at least on classification tag with each merchant category code based on clustering of the merchant category codes on the graph.

Further embodiments or aspects are set forth in the following numbered clauses:

Clause 1: A computer-implemented method for generating a classified map on a computing device comprising: receiving, with at least one processor, statistical data associated with each zone of a plurality of zones; generating, with at least one processor, based on the statistical data at least one classification score for each zone of the plurality of zones by performing a latent factor analysis on the statistical data to generate the at least one classification score; causing to be displayed, with at least one processor, a map of a geographic region having the plurality of zones on a display of a computing device; based at least partially on the at least one classification score, causing to be overlayed, with at least one processor, at least one classification tag over each zone of the plurality of zones on the map to generate the classified map.

Clause 2: The method of clause 1, wherein the statistical data comprises transaction data associated with transactions initiated in each zone of the plurality of zones and merchant category codes associated with the transactions.

Clause 3: The method of clause 1 or 2, wherein the classification score for each zone is generated based at least partially on at least one latent factor score.

Clause 4: The method of any of clauses 1-3, wherein the statistical data comprises socioeconomic data.

Clause 5: The method of any of clauses 1-4, wherein the statistical data comprises a count of transactions initiated in each zone of the plurality of zones sorted by merchant category codes associated with the transactions; wherein generating the at least one classification score comprises performing, with at least one processor, the latent factor analysis on the transaction data to generate at least one latent factor score associated with each merchant category code; wherein generating the at least one classification score further comprises associating at least one classification tag with each merchant category code based at least partially on the at least one latent factor score; and wherein the at least one classification score is based at least partially on the at least one classification tag associated with each merchant category code.

Clause 6: The method of any of clauses 1-5, wherein associating the at least one classification tag with each merchant category code comprises performing a machine learning clustering technique.

Clause 7: The method of any of clauses 1-6, wherein generating the at least one classification score comprises performing, with at least one processor, the latent factor analysis on the transaction data to generate a first latent factor score associated with each merchant category code and a second latent factor score associated with each merchant category code, wherein generating the at least one classification score further comprises plotting a graph of the first latent factor score against the second latent factor score for each merchant category code and associating the at least on classification tag with each merchant category code based on clustering of the merchant category codes on the graph.

Clause 8: A system for generating a classified map on a computing device comprising at least one processor programmed or configured to: receive statistical data associated with each zone of a plurality of zones; generate, based on the statistical data, at least one classification score for each zone of the plurality of zones by performing a latent factor analysis on the statistical data to generate the at least one classification score; cause to be displayed a map of a geographic region having the plurality of zones on a display of a computing device; and based at least partially on the at least one classification score, cause to be overlayed at least one classification tag over each zone of the plurality of zones on the map to generate the classified map.

Clause 9: The system of clause 8, wherein the statistical data comprises transaction data associated with transactions initiated in each zone of the plurality of zones and merchant category codes associated with the transactions.

Clause 10: The system of clause 8 or 9, wherein the classification score for each zone is generated based at least partially on at least one latent factor score.

Clause 11: The system of any of clauses 8-10, wherein the statistical data comprises socioeconomic data.

Clause 12: The system of any of clauses 8-11, wherein the statistical data comprises a count of transactions initiated in each zone of the plurality of zones sorted by merchant category codes associated with the transactions; wherein generating the at least one classification score comprises the at least one processor performing the latent factor analysis on the transaction data to generate at least one latent factor score associated with each merchant category code; wherein generating the at least one classification score comprises the at least one processor associating at least one classification tag with each merchant category code based at least partially on the at least one latent factor score; and wherein the at least one classification score is based at least partially on the at least one classification tag associated with each merchant category code.

Clause 13: The system of any of clauses 8-12, wherein associating the at least one classification tag with each merchant category code comprises the at least one processor performing a machine learning clustering technique.

Clause 14: The system of any of clauses 8-13, wherein generating the at least one classification score comprises the at least one processor performing the latent factor analysis on the transaction data to generate a first latent factor score associated with each merchant category code and a second latent factor score associated with each merchant category code, wherein generating the at least one classification score further comprises the at least one processor plotting a graph of the first latent factor score against the second latent factor score for each merchant category code and associating the at least on classification tag with each merchant category code based on clustering of the merchant category codes on the graph.

Clause 15: A computer program product for generating a classified map on a computing device, the computer program product comprising at least one non-transitory computer-readable medium including one or more instructions that, when executed by at least one processor, cause the at least one processor to: receive statistical data associated with each zone of a plurality of zones; generate, based on the statistical data, at least one classification score for each zone of the plurality of zones by performing a latent factor analysis on the statistical data to generate the at least one classification score; cause to be displayed a map of a geographic region having the plurality of zones on a display of a computing device; and based at least partially on the at least one classification score, cause to be overlayed at least one classification tag over each zone of the plurality of zones on the map to generate the classified map.

Clause 16: The computer program product of clause 15, wherein the statistical data comprises transaction data associated with transactions initiated in each zone of the plurality of zones and merchant category codes associated with the transactions.

Clause 17: The computer program product of clause 15 or 16, wherein the classification score for each zone is generated based at least partially on at least one latent factor score.

Clause 18: The computer program product of any of clauses 15-17, wherein the statistical data comprises socioeconomic data.

Clause 19: The computer program product of any of clauses 15-18, wherein the statistical data comprises a count of transactions initiated in each zone of the plurality of zones sorted by merchant category codes associated with the transactions; wherein generating the at least one classification score comprises the at least one processor performing the latent factor analysis on the transaction data to generate at least one latent factor score associated with each merchant category code; wherein generating the at least one classification score comprises the at least one processor associating at least one classification tag with each merchant category code based at least partially on the at least one latent factor score; and wherein the at least one classification score is based at least partially on the at least one classification tag associated with each merchant category code.

Clause 20: The computer program product of any of clauses 15-19, wherein associating the at least one classification tag with each merchant category code comprises the at least one processor performing a machine learning clustering technique.

Clause 21: The computer program product of any of clauses 15-20, wherein generating the at least one classification score comprises the at least one processor performing the latent factor analysis on the transaction data to generate a first latent factor score associated with each merchant category code and a second latent factor score associated with each merchant category code, wherein generating the at least one classification score further comprises the at least one processor plotting a graph of the first latent factor score against the second latent factor score for each merchant category code and associating the at least on classification tag with each merchant category code based on clustering of the merchant category codes on the graph.

Clause 22: A system for generating a classified map on a computing device comprising: an electronic payment processing network configured to process payment transactions between users and merchants using transaction data associated with the transactions; a database configured to store at least a portion of the transaction data associated with the transactions; and a classification system in communication with the electronic payment processing network and the database, the classification system configured to receive transaction data associated with each zone of a plurality of zones; generate, based on the transaction data, at least one classification score for each zone of the plurality of zones by performing a latent factor analysis on the transaction data to generate at least one latent factor score; cause to be displayed a map of a geographic region having the plurality of zones on a display of a computing device; and based at least partially on the at least one classification score, cause to be overlayed at least one classification tag over each zone of the plurality of zones on the map to generate the classified map.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 shows a schematic view of one non-limiting embodiment or aspect of a system for generating a classified map;

FIG. 2 shows a step diagram of one non-limiting embodiment or aspect of a method for generating a classified map;

FIG. 3 shows one non-limiting embodiment or aspect of a table including statistical data;

FIG. 4 shows one non-limiting embodiment or aspect of a table including normalized statistical data;

FIG. 5A shows one non-limiting embodiment or aspect of a graph of cumulative variance over principal components in a principal component analysis;

FIG. 5B shows one non-limiting embodiment or aspect of a table including principal component analysis data;

FIG. 6 shows one non-limiting embodiment or aspect of a table including latent factor analysis data;

FIG. 7 shows one non-limiting embodiment or aspect of a graph of Factor 1 over Factor 2 from the latent factor analysis data of FIG. 6;

FIG. 8 shows one non-limiting embodiment or aspect of the graph of FIG. 7 including classes associated with the data;

FIG. 9 shows one non-limiting embodiment or aspect of a table including classification scores;

FIG. 10 shows one non-limiting embodiment or aspect of a map of a geographic region having a plurality of zones;

FIG. 11A shows one non-limiting embodiment or aspect of the map of FIG. 10 including classification tags; and

FIG. 11B shows one non-limiting embodiment or aspect of the map of FIG. 10 including classification tags and additional tagging.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “issuer institution” or “issuer” may refer to one or more entities, such as a bank, that provide accounts to customers for conducting transactions (e.g., payment transactions), such as initiating credit and/or debit payments. For example, an issuer institution may provide an account identifier, such as a personal account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer systems operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the portable financial device may include volatile or non-volatile memory to store information (e.g., an account identifier, a name of the account holder, and/or the like).

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. In other non-limiting embodiments, the computing device may be a desktop computer or other non-mobile computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “server” may refer to or include one or more processors or computers, storage devices, or similar computer arrangements that are operated by or facilitate communication and processing for multiple parties in a network environment, such as the internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present disclosure are directed to a method, system, and computer program product for generating a classified map on a computing device. Non-limiting embodiments allows for otherwise subjective classifications of geographic regions to be classified using a more objective analysis, which quantitatively scores each geographic region using relevant statistical data. Non-limiting embodiments allows the classification system to analyze the statistical data to generate classification scores and to overlay classification tags over a map to form a classified map based on the generated classification scores. This classified map may allow users to visualize classifications associated with various geographic regions, in order to make informed decisions based on objective statistical data. Non-limiting embodiments place the classification system in communication with the electronic payment processing network so as to utilize transaction data from an electronic payment processing network as the statistical data for generating the classification scores and the classified map. This transaction data provides a statistically significant sample of data, in that each transaction initiated using a portable financial device may contribute to the dataset, such that a latent factor analysis may be performed to determine factors that objectively indicate the classification associated with a geographic region. In this way, non-limiting embodiments allow data associated with consumer transactions to be provided in such a way to be able to illustrate for users classifications associated with geographic regions, which are displayed via a classified map. This may allow for quicker and more accurate decision making based on the classification associated with a geographic region.

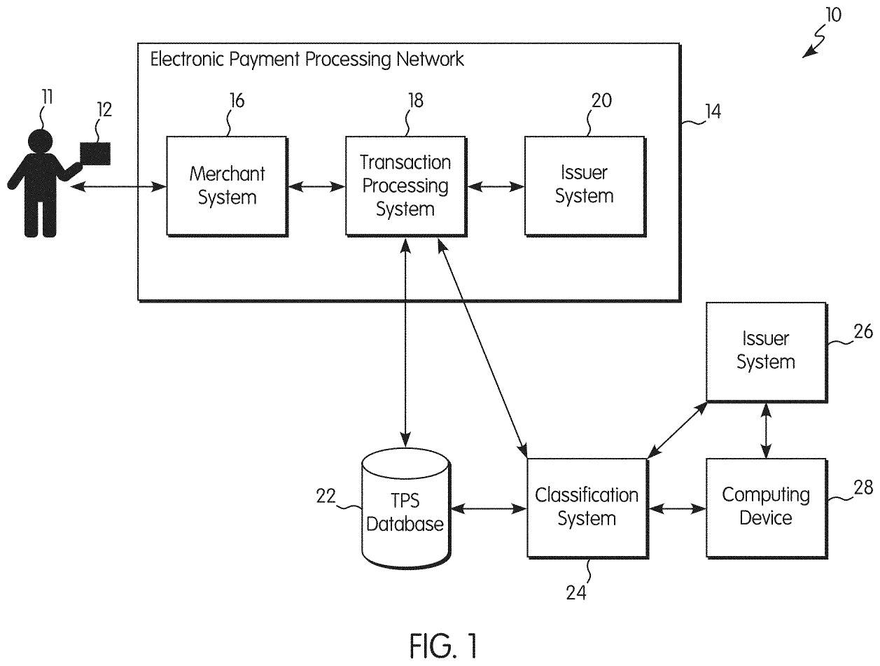

Referring to FIG. 1, a non-limiting embodiment or aspect of a system 10 for generating a classified map on a computing device is shown. In the system 10, a user 11 (e.g., a consumer) may initiate a payment transaction using a portable financial device 12 issued to the user 11. The payment transaction may be processed over an electronic payment processing network 14 including: a merchant system 16 operated by or on behalf of a merchant, a transaction processing system (TPS) 18 operated by or on behalf of a transaction service provider, and an issuer system 20 operated by or on behalf of an issuer. The TPS database 22 may be a part of the TPS 18 or may be a separate database.

With continued reference to FIG. 1, the user 11 may initiate a payment transaction using the portable financial device 12 by communicating the account information associated with the portable financial device to the merchant system 16 (e.g., by swiping the portable financial device at a merchant POS system or by entering the account information into a secure online checkout website during an online transaction). The payment transaction may be processed over the electronic payment processing network 14 by the merchant system 16 communicating a transaction message to the TPS 18. In response to receiving the transaction message, the TPS 18 may communicate an authorization request to the issuer system 20 to cause the issuer system to make an authorization decision regarding the payment transaction. The authorization decision may include to approve or decline the payment transaction. The issuer system 20 may communicate an authorization response to the TPS 18, the authorization response including the authorization decision. The TPS 18 may communicate the authorization decision to the merchant system 16 via a response message. Each payment transaction initiated by a user using a portable financial device associated with the transaction service provider associated with the TPS 18 may be processed in this manner over the electronic payment processing network 14.

As payments are processed over the electronic payment processing network 14 involving the TPS 18, the TPS 18 may collect certain statistical data associated with the transactions being processed. This statistical data collected by the TPS 18 may be stored in a TPS database 22 or may be communicated by the TPS 18 directly to a classification system 24, which will be described in more detail hereinafter.

The statistical data may include transaction data associated with transactions processed over the electronic payment processing network 14. For example, the transaction data may include the data elements defined by ISO 8583, which is an international standard for financial transaction card originated interchange messaging. Non-limiting examples of transaction data include primary account number (PAN), expiration date, CVV code, transaction amount, transaction date, transaction time, merchant identifier, merchant category code, identifier associated with goods and/or service purchased, whether each transaction was approved or declined, zone in which transaction was initiated (e.g., zip code), user name, user residential address, and the like. The transaction data may include any information communicated over the electronic payment processing network 14 in the course of processing a payment transaction.

The statistical data may include socioeconomic data. The socioeconomic data may include socioeconomic data associated with the user initiating the payment transaction, such as gender, age, ethnicity, race, occupation, household income, marital status, and the like.

The statistical data (e.g., the transaction data and/or socioeconomic data) may include any of the previously discussed statistical data sorted by geographic zones. As one non-limiting example, the transaction data may include data associated with merchant category codes associated with processed payment transactions, and the data associated with the merchant category codes may be sorted by geographic region in which that payment transaction was initiated, such that a count of transactions initiated in each geographic zone by merchant category code is ascertained. The geographic zone may be any definable geographic region. In some non-limiting embodiments, the geographic zone is a neighborhood, school district, zip code, township, town, municipality, borough, city, district, county, parish, state, commonwealth, province, territory, colony, country, continent, hemisphere, or some collection or combination thereof.

With continued reference to FIG. 1, the system 10 may include a classification system 24. The classification system 24 may refer to one or more computer systems operated by or on behalf of a transaction service provider, an issuer, a merchant, or other third-party entity. The classification system 24 may include one or more processors. The classification system 24 may be in communication with the TPS 18 and/or the TPS database 22 to receive the statistical data. Thus, the classification system 24 may be in communication with the electronic payment processing network 14. The classification system 24 may also be in communication with a maps system 26 and/or a computing device 28, as described hereinafter.

The classification system 24 may receive the previously-described statistical data, such as the transaction data associated with a plurality of zones. In response to receiving the statistical data, the classification system 24 may analyze the statistical data and generate, at least one classification score based on the statistical data. The classification score may be generated based at least partially on the at least one latent factor score. Example classification scores may include a numerical score (e.g., a score between 0 and 100), a level (e.g., low, medium, high), an alphabetical grade (e.g., A, B, C, D, F, etc.), or any other conceivable scoring system.

The classification score may be associated with at least one class. A “class” may refer to a number of persons or things (e.g., a zone) regarded as forming a group by reason of common attributes, characteristics, qualities, or traits. For example, the classification score may quantify the degree to which a zone represents a specific class. The classification score may specify (e.g., quantify) the degree to which a zone is, for example, affluent, affordable, youthful, educated, technophilic, physically active, politically active, outdoorsy, hipster, industrial, agricultural, health conscious, and other like classes.

The classification score may be generated for each zone of the plurality of zones. In one non-limiting example, the classification score for each zone may be generated by the classification system 24 performing a latent factor analysis on the statistical data to generate at least one latent factor score. Non-limiting examples of the classification system 24 generating the classification score for each zone will be detailed hereinafter.

With continued reference to FIG. 1, in response to the classification system 24 generating the classification score for each zone, the classification system may cause a map of a geographic region having the plurality of zones to be displayed on a display of the computing device 28. In some non-limiting embodiments, the classification system 24 may communicate with the maps system 26 to receive a map of the geographic region having the zones and may communicate that map to the computing device 28, such that the map is displayed on the computing device. In some non-limiting embodiments, the classification system may communicate with the maps system 26 to cause the maps system 26 to communicate a map of the geographic region having the zones to the computing device 28, to be displayed thereon. The maps system 26 may be a part of the classification system 24 or may be a separate system. The maps system may be Google Maps or any other web mapping service. The maps system 26 may be a server for generation of an API, in order to communicate with Google Maps or other web mapping service.

With continued reference to FIG. 1, the classification system 24 may cause at least one classification tag to be overlayed over each zone of the plurality of zones on the map displayed on the computing device 28 to generate a classified map. The classification tags may be caused to be overlayed by the classification system 24 based on the generated classification scores. The classification tag may be a label over the zone to label the zone as being associated with that class. The classification tag may include a color or pattern that visually indicates to the viewer of the computing device 28 that the zone is associated with a particular classification tag. The classification tag may indicate the degree to which the zone is associated with that class (e.g., a lighter or darker shade of the color of the classification tag).

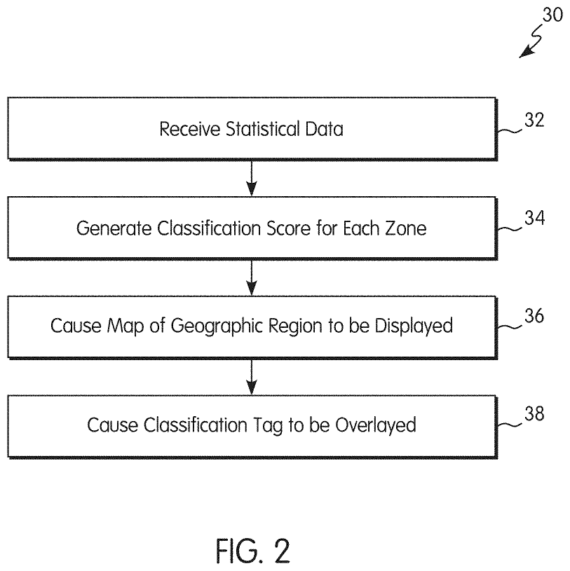

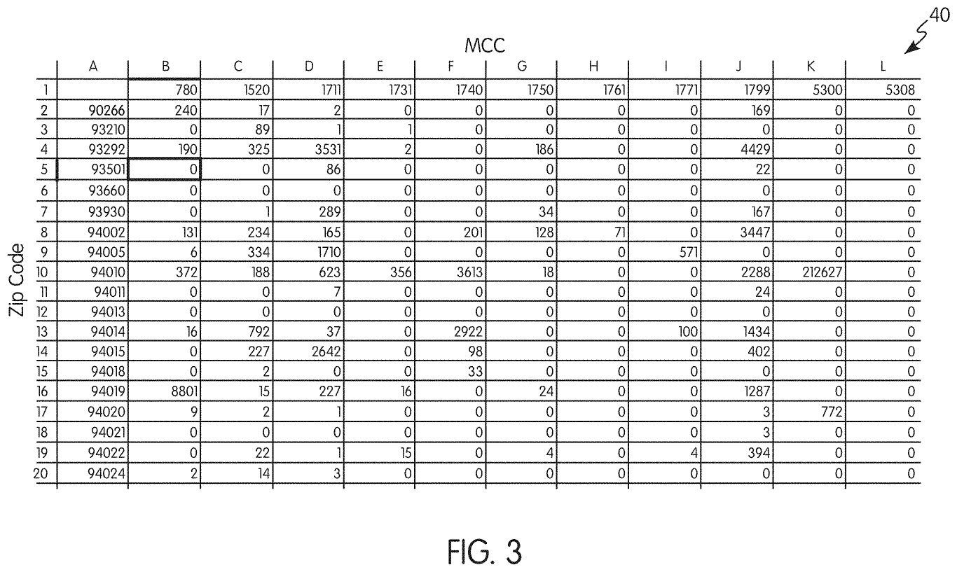

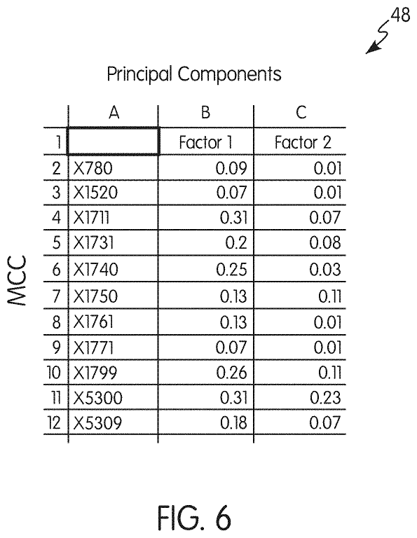

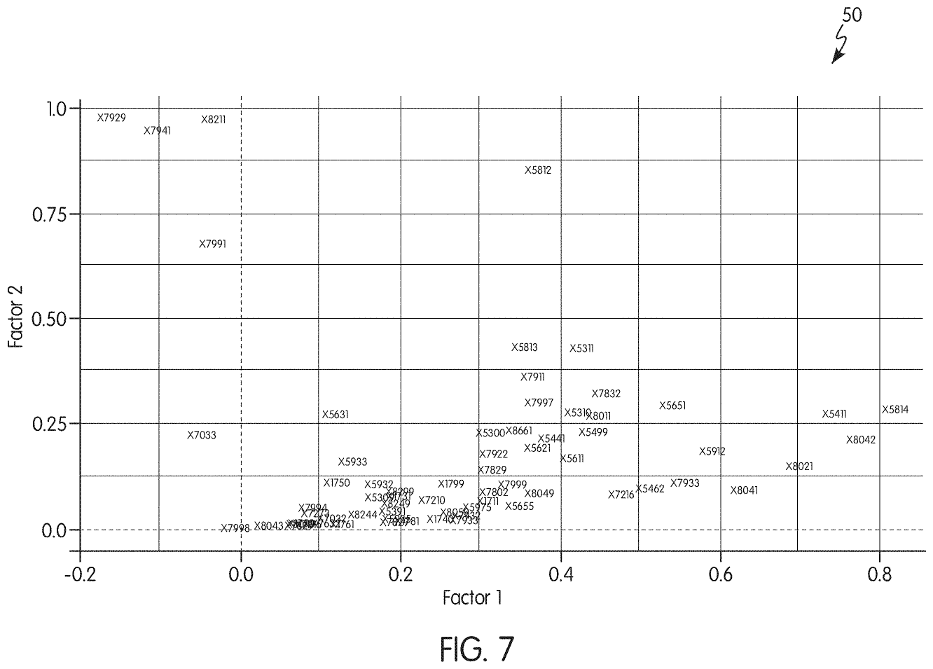

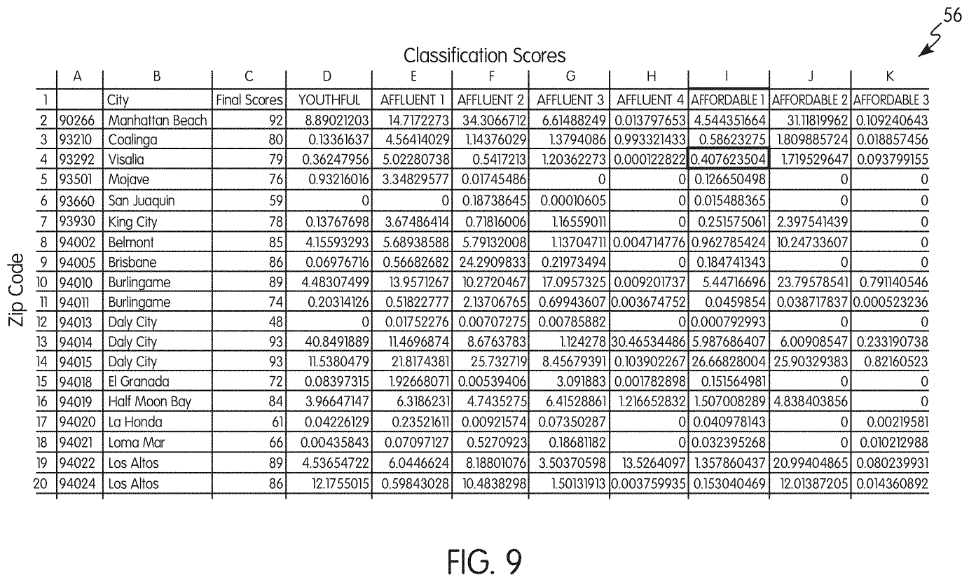

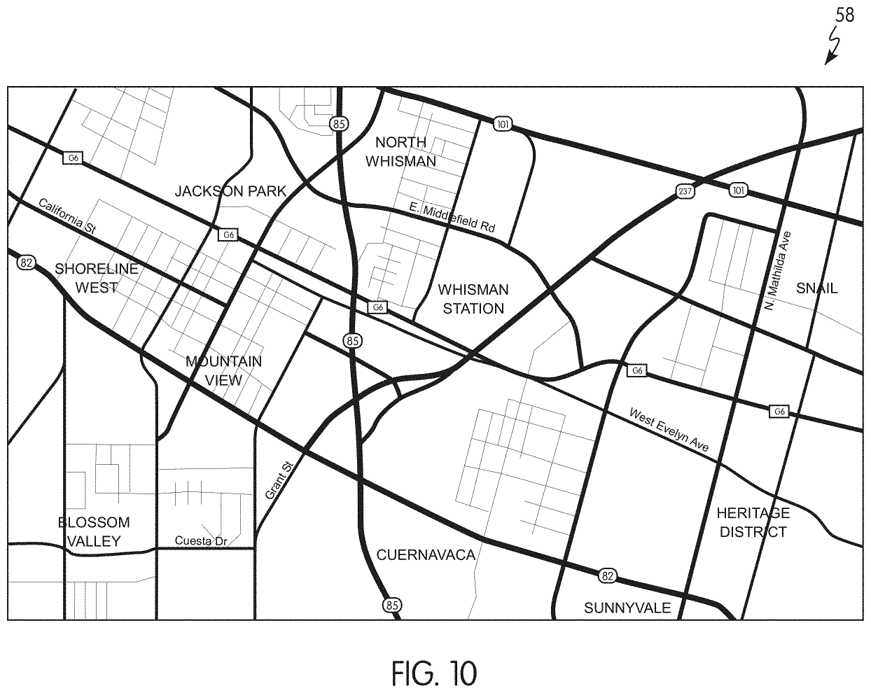

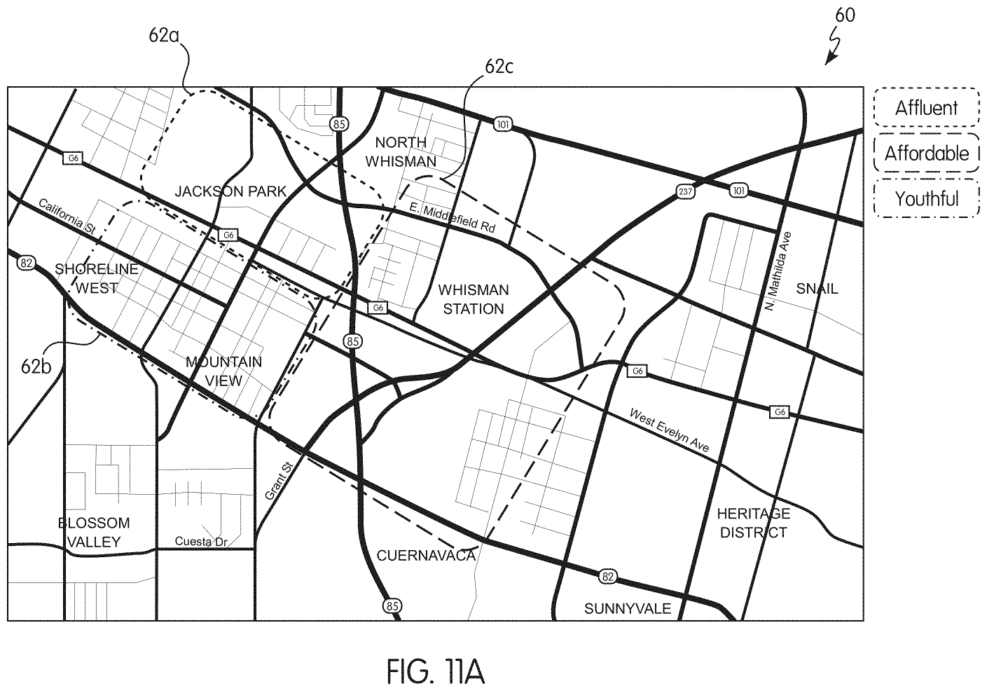

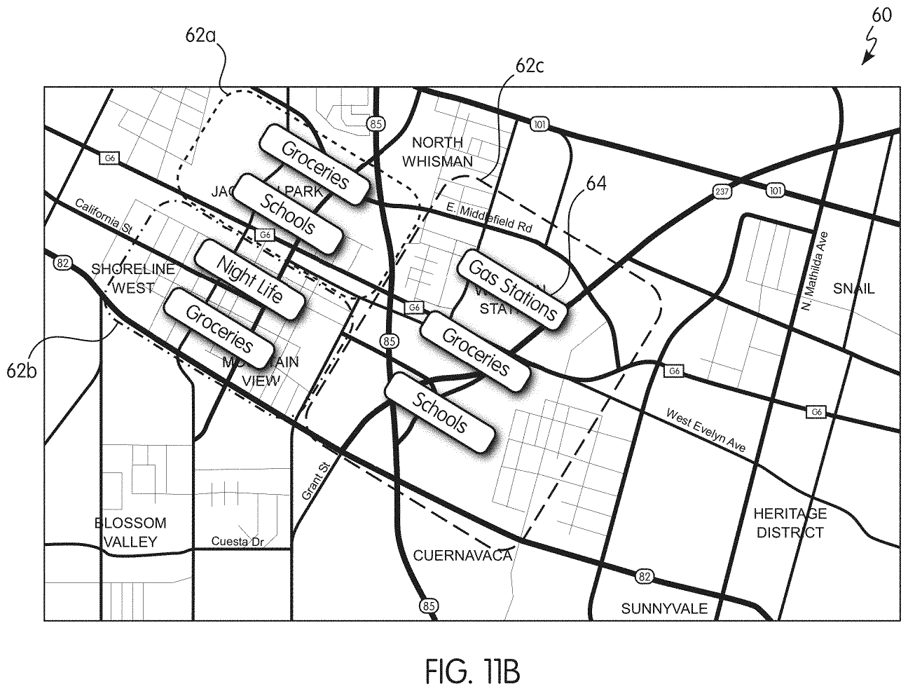

Referring to FIG. 2, a computer-implemented method 30 for generating a classified map on the computing device 28 is shown. A first step 32 may include receiving, with the classification system 24, statistical data (see FIGS. 3-8) associated with each zone of a plurality of zones. A second step 34 may include generating, with the classification system 24, based on the statistical data at least one classification score (see FIG. 9) for each zone of the plurality of zones by performing a latent factor analysis (see FIGS. 6 and 7) on the statistical data to generate at least one latent factor score. A third step 36 may include causing to be displayed, with the classification system 24, a map of a geographic region having the plurality of zones on a display of a computing device (see FIG. 10). A fourth step 38 may include, based at least partially on the at least one classification score, causing to be overlayed, with the classification system 24, at least one classification tag over each zone of the plurality of zones on the map to generate the classified map (see FIGS. 11A-11B).

In a further, non-limiting embodiment or aspect, a computer program product for generating a classified map on a computing device includes at least one non-transitory computer readable medium including program instructions that, when executed by at least one processor, cause the at least one processor to execute any of the methods described herein. The at least one processor may include the classification system 24.

The following example is provided to illustrate an embodiment of the system, method, and computer program product for generating a classified map on a computing device, and is not meant to be limiting.

Referring back to FIG. 1, the TPS 18 may collect statistical data over the electronic payment processing network 14 in connection with payment transactions between users and merchants, as previously described.

Referring to FIG. 3, in this particular non-limiting example, a table 40 of the statistical data includes transaction data associated with transactions initiated over the electronic payment processing network 14 in each zone of a plurality of zones, the zones being zip codes. The statistical data includes a count of transactions initiated in each zip code sorted by merchant category code associated with the transactions. The rows of data in the table 40 of FIG. 3 correspond to zip codes, and each column corresponds to a merchant category code. Each cell in the table 40 corresponds to a count of the number of payment transactions associated with a particular merchant category code that were initiated in each zip code over a predetermined time period.

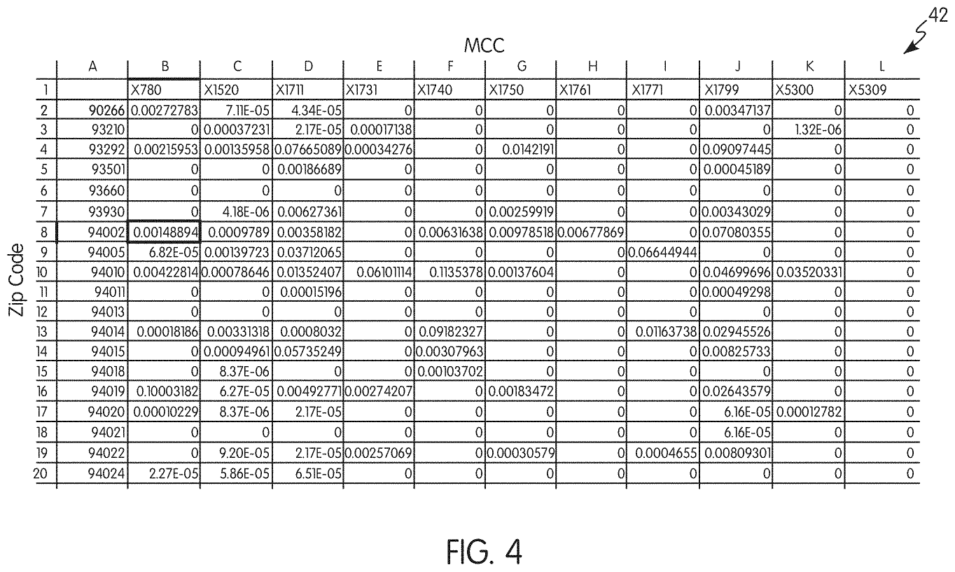

Referring to FIG. 4, a table 42 is shown in which the data from the table 40 in FIG. 3 is normalized to create normalized statistical data. Either the statistical data from the table 40 in FIG. 3 or the normalized statistical data from the table 42 in FIG. 4 may be used. The normalized statistical data may bring all values in the table between 0 and 1 with 0 representing a transaction count of 0 and 1 representing a maximum transaction count for the data. Normalizing the data may eliminate some bias and may provide a scale for measurement.

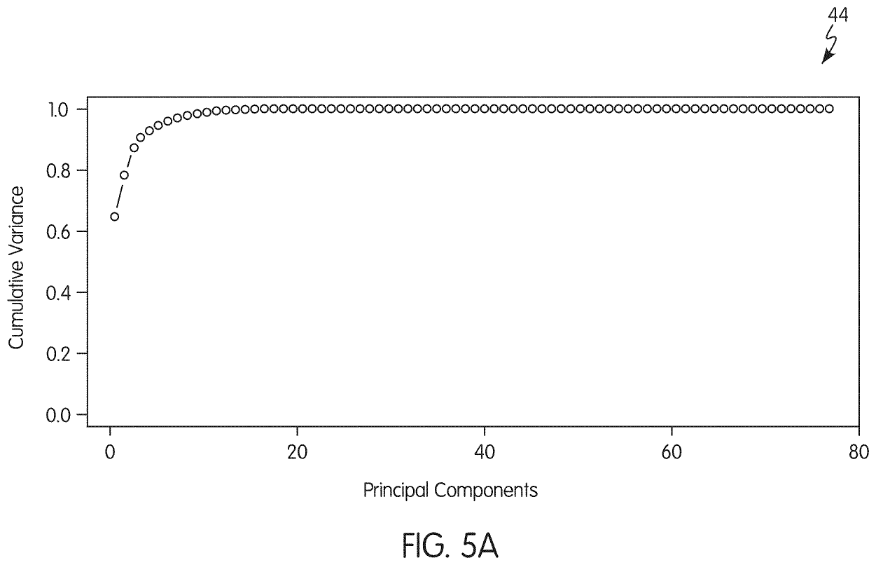

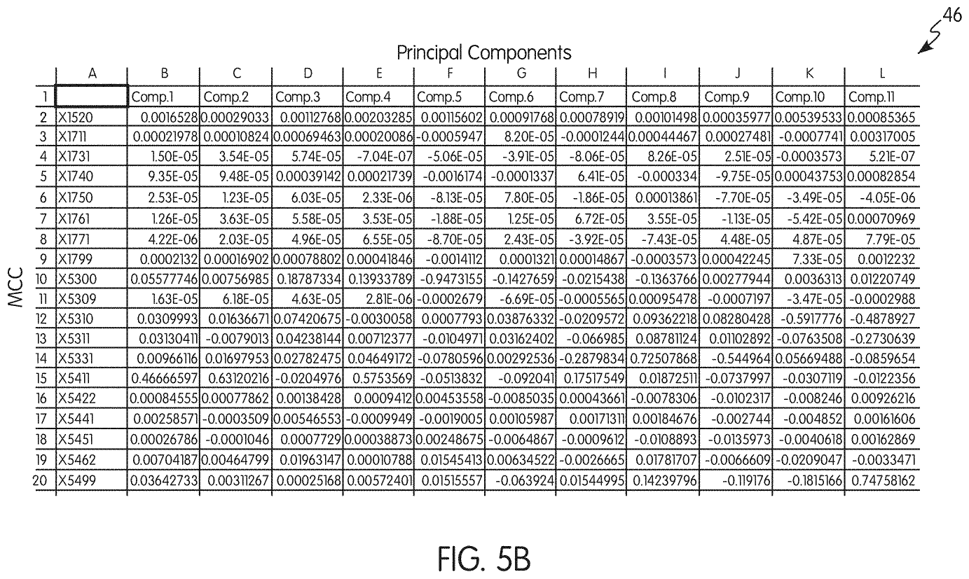

Referring to FIGS. 5A-5B, the statistical data, such as the normalized statistical data from table 42 of FIG. 4, may be analyzed using principal component analysis (PCA). By running a PCA on the normalized statistical data, a graph 44 of cumulative variance over principal components generated by the PCA can be generated, which is shown in FIG. 4, and the results of the PCA can be shown in the table 46 in FIG. 5B. The rows of the table 46 in FIG. 5B each represent the merchant category codes (original variables), and each column represents a principal component (factor) generated by the PCA. The data in the table 46 in FIG. 5B represent factor loadings, which represent a correlation between the original variable and the factors. From the graph 44 in FIG. 5A, it can be seen that running a PCA on the normalized statistical data can be reduced to two columns (two principal components) while preserving approximately 80% of the information. This loss of 20% of the information may be justified based on the simplification of the data from 78 columns (one for each merchant category code) to 2 columns. It will be appreciated that these two principal components to which the data is reduced to do not in themselves represent a transaction count of merchant category code transactions in a zip code, but they represent a new characteristic that effectively summarizes the original 78 columns of normalized statistical data. This PCA helps to determine that the normalized statistical data may be reduced to two principal components while preserving approximately 80% of the data.

After it has been determined that the data can be reduced to two components while preserving an acceptable amount of data, a latent factor analysis (LFA) may be applied to the data. This LFA technique not only performs PCA as part of its initial processing but also generates a ‘latent’ or un-observed variable for all row elements (merchant category codes). Referring to FIG. 6, a table 48 of the output of the LFA is shown. Each row in the table 48 of FIG. 6 represents a merchant category code (original variables), and each column represents a factor (principal component) generated by the LFA. The data in the table 48 in FIG. 6 represent factor loadings, which represent a correlation between the original variable and the factors. In the non-limiting example in FIG. 6, two factors (Factor 1 and Factor 2) result from the LFA, and each merchant category code has a first latent factor score (loading) associated with Factor 1 and a second latent factor score (loading) associated with Factor 2.

Referring to FIG. 7, a graph 50 may be generated that plots the second latent factor score against the first latent factor score for each merchant category code. As can be seen from the graph 50 of FIG. 7 a set of x and y coordinates may be associated with each merchant category code such that each merchant category code has a position on the graph 50.

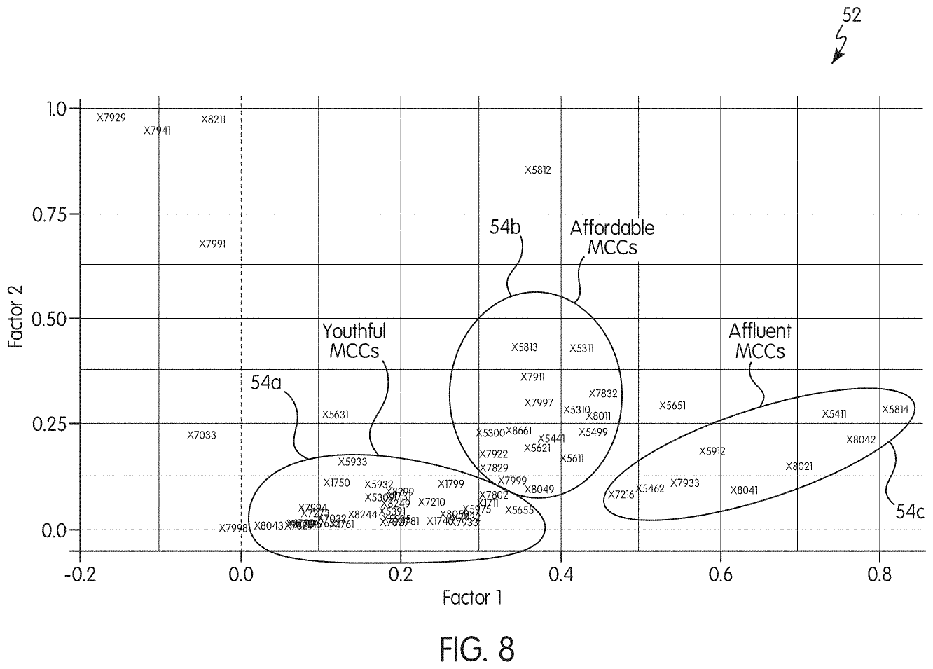

Referring to FIG. 8, a graph 52 associating classes 54a-54c with plotted merchant category codes is shown. Merchant category code may be grouped into classes 54a-54c based on their proximity to one another. The classes may be any of the previously described classes. For example, certain merchant category codes may be associated with a ‘youthful’ class 54a, certain merchant category codes may be associated with an ‘affordable’ class 54b, and certain merchant category codes may be associated with an ‘affluent’ class 54c. In some non-limiting examples, a merchant category code belongs to only a single class. In some non-limiting examples, a merchant category code may belong to a plurality of different classes.

With continued reference to FIG. 8, the classes 54a-54c may be associated with merchant category codes based on a human operator analyzing the data to suggest which class certain merchant category codes belong. However, in other examples, the classes 54a-54c may be associated with merchant category codes automatically, such as based on a machine learning clustering technique. Non-limiting examples of suitable machine learning clustering techniques include K-Means clustering or K-Nearest neighbors clustering.

Referring to FIG. 9, based on the classes 54a-54c associated with each merchant category code, at least one classification score may be generated for each zone. A table 56 shown in FIG. 9 shows the classification scores by zone. The rows of the table 56 correspond to zip codes, and the columns D-K represent classes. The data associated with each row associated with columns D-K represent classification scores associated with each class. Each class may include several classification scores (e.g., Columns E-H are all affluent classification scores based on different algorithms). Each classification score is determined based on an algorithm based on the statistical data (e.g., the transaction count or normalized transaction count for each MCC after each MCC has been classified).

Column C from the table 56 in FIG. 9 represents an overall score, which may include the sum of a plurality of classification scores to characterize the class of the zone overall. The overall score may represent the overall characterization of the particular zone. In some non-limiting examples, no overall score is determined, but only scores associated with each individual classification are determined. For example, for the classes 54a-54c from FIG. 8, an affluent score, an affordable score, and a youthful score may be generated for each zone. Also, an overall score that includes an algorithm representing some combination of the affluent score(s), the affordable score(s), and/or the youthful score(s) may also be determined to give the overall (“vibe”) score for each zone.

Referring to FIG. 10, a map 58 of the geographic region showing the plurality of zones is shown. This map 58 may be caused to be displayed by the classification system on the computing device of the user.

Referring to FIGS. 11A-11B, a classified map 60 of the geographic region showing the plurality of zones is shown. The classified may 60 may include the map 58 from FIG. 10 and at least one classification tag 62a-62c over at least one of the zones. The classification tags 62a-62c may associate each of the zones with a particular class. For example, the zone labeled 62a in FIG. 11A corresponds to an affluent zone based on the affluent classification tag; the zone labeled 62b corresponds to a youthful zone based on the youthful classification tag; and the zone labeled 62c corresponds to an affordable zone based on the affordable classification tag.

It will be appreciated that other variations of classification tags may be used. For example, the classification tags may specify the degree to which a zone is associated with a specific class by displaying the classification score associated with that class or using a shade of a color associated with that class. For example, a zone labeled as a youthful zone may display a youthful classification score between 0-100, based on the degree to which that zone can be characterized as youthful, with 0 being the least youthful zone and 100 being the most youthful zone. In another example, blue may be a color of a classification tag associated with a youthful zone, and more youthful zones may receive a darker blue classification tag and less youthful zones may receive a lighter blue classification tag, such that the shade of the classification tag may indicate the relative degree to which that zone is associated with that class.

Each zone may receive a single classification tag, or each zone may include multiple classification tags. The user may interact with the classified map 60 so as to request the classification tags to be displayed. For example, the user may interact with the classified map 60 so as to see the degree to which each zone is associated with a certain class (e.g., how ‘youthful’ each zone is). In another example, the user may interact with the classified map 60 so that only the classification tag associated with the class each zone is most strongly associated with is shown.

In another non-limiting example as shown in FIG. 11 B, the classified map 60 may include additional tagging 64. The additional tagging 64 may, for example, indicate the merchant types (based on merchant category code) associated with each zone. The additional tagging 64 may include other relevant information, such as statistical data associated with transactions conducted in each zone.

Based on this non-limiting example, it is clear that a user may view the classified map 60 which is generated by a unique, unconventional arrangement of the electronic payment processing network 14 being in communication with the classification system 24. The LFA of the statistical data from the electronic payment processing network 14 allows latent factors from the statistical data to be determined as they relate to specific characteristics (classes) associated with geographic zones. This allows a user to more readily understand geographic zones based on certain data received by certain entities (e.g., transaction service provider and/or issuers) in statistically significant amounts.

In the example shown in FIGS. 3-11A, the statistical data included count of transactions initiated during a specified time period sorted by merchant category code. However, it will be appreciated that other types of statistical data (e.g., transaction data associated with transactions) for each zone may be utilized in order to generate the classified map as disclosed herein. For example, any data associated with ISO 8583 or any other data collected by any system of any entity (e.g., merchant, transaction service provider, issuer) operating within the electronic payment processing network 14 sorted by zone may be utilized. Further other types analysis in addition to or in lieu of the PCA and LFA may be utilized to generate the classification score(s) associated with each zone.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method for generating a classified map on a computing device comprising:
receiving, with at least one processor, statistical data associated with each zone of a plurality of zones;
generating, with at least one processor and based on the statistical data, at least one classification score for each zone of the plurality of zones by performing a latent factor analysis on the statistical data to generate the at least one classification score;
causing, with at least one processor, a map of a geographic region having the plurality of zones to be displayed on a display of a computing device; and
based at least partially on the at least one classification score, causing to be overlayed, with at least one processor, at least one classification tag over each zone of the plurality of zones on the map to generate the classified map.

2. The method of claim 1, wherein the statistical data comprises transaction data associated with transactions initiated in each zone of the plurality of zones and merchant category codes associated with the transactions.

3. The method of claim 1, wherein the at least one classification score for each zone is generated based at least partially on at least one latent factor score.

4. The method of claim 1, wherein the statistical data comprises socioeconomic data.

5. The method of claim 2, wherein the statistical data comprises a count of transactions initiated in each zone of the plurality of zones sorted by merchant category codes associated with the transactions;
wherein generating the at least one classification score comprises performing, with at least one processor, the latent factor analysis on the transaction data to generate at least one latent factor score associated with each merchant category code;
wherein generating the at least one classification score further comprises associating at least one classification tag with each merchant category code based at least partially on the at least one latent factor score; and
wherein the at least one classification score is based at least partially on the at least one classification tag associated with each merchant category code.

6. The method of claim 5, wherein associating the at least one classification tag with each merchant category code comprises performing a machine learning clustering technique.

7. The method of claim 5, wherein generating the at least one classification score comprises performing, with at least one processor, the latent factor analysis on the transaction data to generate a first latent factor score associated with each merchant category code and a second latent factor score associated with each merchant category code,
wherein generating the at least one classification score further comprises plotting a graph of the first latent factor score against the second latent factor score for each merchant category code and associating the at least on classification tag with each merchant category code based on clustering of the merchant category codes on the graph.

8. A system for generating a classified map on a computing device comprising at least one processor programmed or configured to:
receive statistical data associated with each zone of a plurality of zones;
generate, based on the statistical data, at least one classification score for each zone of the plurality of zones by performing a latent factor analysis on the statistical data to generate the at least one classification score;
cause a map of a geographic region having the plurality of zones to be displayed on a display of a computing device; and
based at least partially on the at least one classification score, cause to be overlayed at least one classification tag over each zone of the plurality of zones on the map to generate the classified map.

9. The system of claim 8, wherein the statistical data comprises transaction data associated with transactions initiated in each zone of the plurality of zones and merchant category codes associated with the transactions.

10. The system of claim 8, wherein the classification score for each zone is generated based at least partially on at least one latent factor score.

11. The system of claim 8, wherein the statistical data comprises socioeconomic data.

12. The system of claim 9, wherein the statistical data comprises a count of transactions initiated in each zone of the plurality of zones sorted by merchant category codes associated with the transactions;
wherein generating the at least one classification score comprises the at least one processor performing the latent factor analysis on the transaction data to generate at least one latent factor score associated with each merchant category code;
wherein generating the at least one classification score comprises the at least one processor associating at least one classification tag with each merchant category code based at least partially on the at least one latent factor score; and
wherein the at least one classification score is based at least partially on the at least one classification tag associated with each merchant category code.

13. The system of claim 12, wherein associating the at least one classification tag with each merchant category code comprises the at least one processor performing a machine learning clustering technique.

14. The system of claim 12, wherein generating the at least one classification score comprises the at least one processor performing the latent factor analysis on the transaction data to generate a first latent factor score associated with each merchant category code and a second latent factor score associated with each merchant category code,
wherein generating the at least one classification score further comprises the at least one processor plotting a graph of the first latent factor score against the second latent factor score for each merchant category code and associating the at least on classification tag with each merchant category code based on clustering of the merchant category codes on the graph.

15. A computer program product for generating a classified map on a computing device, the computer program product comprising at least one non-transitory computer-readable medium including one or more instructions that, when executed by at least one processor, cause the at least one processor to:
receive statistical data associated with each zone of a plurality of zones;
generate, based on the statistical data, at least one classification score for each zone of the plurality of zones by performing a latent factor analysis on the statistical data to generate the at least one classification score;
cause to be displayed a map of a geographic region having the plurality of zones on a display of a computing device; and
based at least partially on the at least one classification score, cause to be overlayed at least one classification tag over each zone of the plurality of zones on the map to generate the classified map.

16. The computer program product of claim 15, wherein the statistical data comprises transaction data associated with transactions initiated in each zone of the plurality of zones and merchant category codes associated with the transactions.

17. The computer program product of claim 15, wherein the classification score for each zone is generated based at least partially on at least one latent factor score.

18. The computer program product of claim 15, wherein the statistical data comprises socioeconomic data.

19. The computer program product of claim 15, wherein the statistical data comprises a count of transactions initiated in each zone of the plurality of zones sorted by merchant category codes associated with the transactions;
wherein generating the at least one classification score comprises the at least one processor performing the latent factor analysis on the transaction data to generate at least one latent factor score associated with each merchant category code;
wherein generating the at least one classification score comprises the at least one processor associating at least one classification tag with each merchant category code based at least partially on the at least one latent factor score; and
wherein the at least one classification score is based at least partially on the at least one classification tag associated with each merchant category code.

20. The computer program product of claim 19, wherein associating the at least one classification tag with each merchant category code comprises the at least one processor performing a machine learning clustering technique.

21. The computer program product of claim 19, wherein generating the at least one classification score comprises the at least one processor performing the latent factor analysis on the transaction data to generate a first latent factor score associated with each merchant category code and a second latent factor score associated with each merchant category code,
wherein generating the at least one classification score further comprises the at least one processor plotting a graph of the first latent factor score against the second latent factor score for each merchant category code and associating the at least on classification tag with each merchant category code based on clustering of the merchant category codes on the graph.
